(19) United States
(12) Patent Application Publication
(10) Pub. No.: US 2020/0193382 A1
(43) Pub. Date: Jun. 18, 2020

(54) EMPLOYMENT RESOURCE SYSTEM, METHOD AND APPARATUS

(71) Applicant: Robert P. Michaels, Pacific Palisades, CA (US)

(72) Inventor: Robert P. Michaels, Pacific Palisades, CA (US)

(21) Appl. No.: 16/222,420

(22) Filed: Dec. 17, 2018

(51) Int. Cl. G06Q 10/10; G06N 20/00

(52) U.S. Cl. CPC G06Q 10/1053; G06N 20/00

(57) ABSTRACT

A system, method and apparatus for semantically evaluating and matching resumes with job descriptions, and vice versa, is presented. The system may include learned word embeddings and/or learned phrase embeddings and trained models to evaluate the context and meaning of the text within each document. The system may rate the relevance of each document with respect to other documents, and to use the context and meaning to find the most relevant matches between the documents.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### FIELD OF INVENTION

The field of the invention generally relates to comparing the context of various documents, and in particular, to a system, method and apparatus to match resumes with job descriptions (or vice versa) using semantic evaluations.

### BACKGROUND OF INVENTION

It is not uncommon for job seekers to search for employment by using the Internet. In fact, there are a multitude of employment websites that allow employers to post job descriptions that the job seekers may review. And if a job seeker feels that he/she may be qualified for the open position, the job seeker may submit his/her resume to the employer for consideration.

However, there are many problems with the way in which these employment sites may operate. First, the job descriptions may be searchable by “key words” which may unnecessarily limit the breadth of the searches. Second, because many job descriptions may include terms that may have multiple meanings, the search results may include job postings that are in fact irrelevant to the job seeker. Third, job descriptions may be poorly written which may exasperate the situation. Fourth, it may be up to the job seeker to determine whether or not they may be a good match for the open position. Fifth, the systems may only provide for a limited number of search criteria, and may not provide search criteria on topics that may be of interest to the job seeker (e.g., driving time to and from the place of employment).

Due to these shortcomings, the systems may not provide accurate information to the job seekers and/or the employers. This may result in a significant amount of wasted time and money.

Accordingly, there is a need for an employment resource system and method that may better evaluate the job descriptions and/or the resumes in order to provide higher quality matches between the job seekers and the employers. There is also a need for a system and method that may use semantic evaluations to better understand the meaning and the context of the text within the job descriptions and/or the resumes such that the resumes and job descriptions may be better understood and paired.

### BRIEF DESCRIPTIONS OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification. None of the drawings are to scale unless specifically stated otherwise.

FIGS. 1-2 show aspects of a framework of an employment resource system according to exemplary embodiments hereof;

FIGS. 3A and 3B depict aspects of an employment resource system according to exemplary embodiments hereof;

FIGS. 4-17 show aspects of system dialogs of an employment resource system according to exemplary embodiments hereof; and

FIG. 18 shows aspects of a computing system according to exemplary embodiments hereof; and

### DETAILED DESCRIPTION OF THE PREFERRED EMBODIMENTS

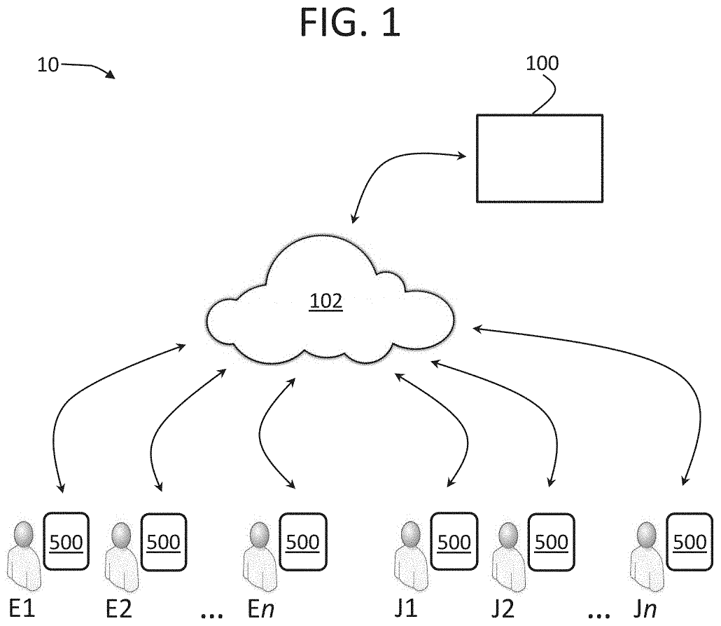

A system or framework according to exemplary embodiments of the current invention is described with reference to FIGS. 1-18.

In general, the system 10 may include an employment resource system, method and apparatus. For the purposes of this specification, an employment resource system may include any type of system that may provide functionalities relating to, without limitation, the posting of employment opportunities by employers, the posting of resumes by job-seekers, the searching for employment opportunities by job-seekers, the matching of resumes with job openings, the recommending of resumes to employers, the recommending of job openings to job-seekers, the providing of career advice, the providing of hiring resources, the providing of job-seeking resources, and other activities that may generally relate to the seeking of job candidates and/or of job opportunities.

In one exemplary embodiment, the system 10 may utilize semantic evaluation(s) of resumes and/or of job descriptions to understand the context and meaning of the words within each document, and to determine the best match(es) between the documents. In this way, the system 10 may more closely emulate how an employment recruiter may use his/her experience, knowledge and understanding of the content of the resume(s) and/or the job posting(s) to find the best matches there between.

In one exemplary embodiment hereof, the system 10 may include a system and/or platform (e.g., a web-based platform, website, mobile application, etc.) that may allow employers to post job openings and job-seekers to post resumes. The system 10 may then use semantic matching to match the job-seeker resume(s) with applicable employer job opening(s). While the term resume may be used in this specification to generally refer to a document (hard copy and/or electronic) that may generally outline a person's job experience, school experience, interests and other information, it is understood by a person of ordinary skill in the art that the use of the term resume in this specification may also include other types of documents or data presentations that may include the same or similar information (e.g., bios). It is also understood that a job-seeker may provide the information to the system 10 using other methods such as entering the information into an input field presented by the system 10 (e.g., on a website), by interacting with an online wizard, by filling out an online form, or by other information providing methods. It is also understood that an employer may provide information to the system 10 regarding job opportunities/posts and/or job descriptions using the same or similar methods.

In one preferred implementation, the system 10 may group the resumes and job opportunities together by standard job title(s) for each particular industry(s) of interest. It is understood however that the resumes and job descriptions may be grouped together using any other information or topics and that the scope of the system 10 is not limited in any way by the way in which the resumes and/or job descriptions may be grouped or otherwise organized.

The grouping process may return metrics relating to the relevance of each resume and/or each job description within each group (e.g., percentages of relevancy or other types of metrics) as well as other information such as skills related to each topic (e.g., skills related to each standard job title) that may be referenced in the resumes and/or the job descriptions. Note that the metrics and/or the other information may be based on the semantic evaluations of the resumes and/or the job descriptions, and therefore may be based on the meaning of the texts (e.g., the text within the resumes and/or the job descriptions) and not necessarily on word match. This may help provide the context and meaning of the resumes and job descriptions, thereby leading to more accurate pairing(s).

In general, the system 10 may utilize word embedding (WE) models and/or phrase embedding (PE) models to train its algorithm(s) and semantically evaluate the resumes and/or job descriptions for matches. As is known in the art, a word embedding may be a learned representation of text where words that may have the same or similar meaning may have a similar representation. Each word may be represented by a real-valued vector and the word embedding methods may use a corpus of text to learn the real-valued vector representations of a set of vocabulary. Phrase embedding may be similar to word embedding but may include two or more words.

The system 10 may utilize pre-trained word embeddings and/or pre-trained phrase embeddings, may learn new word embeddings and/or new phrase embeddings for one or more vocabulary(s) of interest, or any combination thereof.

In one preferred implementation, the system 10 may learn new word and phrase embeddings for a specific vocabulary. For example, the system may learn word and phrase embeddings for the employment industry, and may therefore learn embeddings for job titles, task descriptions, etc. across a multitude of industries. This will be described in further detail in other sections of this specification.

Once the word and phrase embeddings are learned (trained), they may be used to train other model(s) of the system 10 that may match the resumes with the job descriptions and/or vice versa.

Various components or parts of the system 100 are described now in greater detail.

As shown in FIG. 1, in one exemplary embodiment hereof the system 10 may include a controller. In one preferred implementation, the controller may be a backend or cloud platform 100. The backend or cloud platform 300 may include one or more servers (e.g., Internet servers) that may include CPUs, GPUs, memory, software, operating systems, firmware, databases, network cards and any other elements and/or components that may be required for the backend platform 100 to perform its functionalities.

The cloud platform 100 may be connected to a network (e.g., the Internet, a LAN, a WAN or any other type(s) of networks) such that users may interact with the system 10 and with the cloud platform 100 through the network 102. The users of the system 10 may generally include without limitation, employers En and job-seekers Jn. As shown, the users En, Jn may utilize devices 500 to share data with and to receive data from the system 10 (e.g., the cloud platform 100) through the network 102. Accordingly, it may be preferable that the devices 500 may be connected to the network 102 when the users En, Jn may desire to interact with the system 10. The devices 500 may include a browser, a mobile application, or other type of interface that may allow the devices 500 to connect to the network 102 and interact with the system 10. It may be preferable that the system 10 provide its functionalities to the users En, Jn through the browser, the mobile application or through other interfaces. The devices 500 may include without limitation, mobile phones, tablet computers, laptop computers, personal computers, servers, and other types of devices. It is understood that the devices 500 need not match from one user En, Jn to another.

The cloud platform 100 may include one or more databases that may be used to store the resumes and/or the job descriptions. In one exemplary implementation, the job-seekers may upload his/her resume(s) to the database(s), and the employers may upload their job descriptions to the database(s). The system 10 may then make at least some of the resumes and/or job descriptions (job posts) available for review by the public (e.g., registered uses of the system 10). The system 10 may also evaluate the documents for matches as described in detail below.

In one exemplary embodiment hereof, the system 10 may preferably perform the following acts:

1. Preprocess resumes and/or job descriptions. This may be performed 10 in order to provide the text within each document to the system 10 in a form that the system 10 may utilize.

2. Train the system 10 word embedding models and/or phrase embedding models using the preprocessed resumes and/or job descriptions

3. Use the trained word embeddings and/or the trained phrase embeddings to train other models within the system 10.

4. Match new resumes with new job openings and vice versa

It is understood by a person of ordinary skill in the art that the acts shown above are for demonstration and that the system 10 may also perform other acts not listed, may not perform all of the acts listed at all times, and/or may perform any of the acts in different order(s). It is also understood that the scope of the system 10 is not limited in any way by the acts that it may perform.

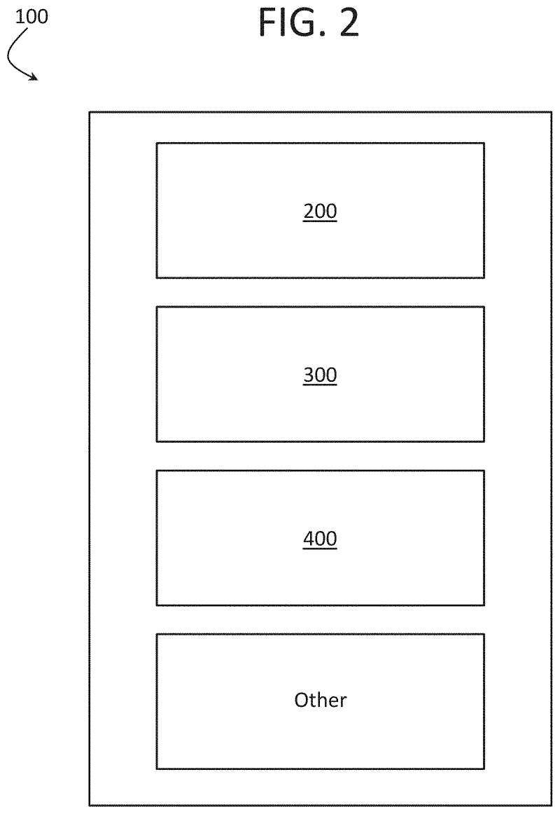

As shown in FIG. 2, in one exemplary embodiment hereof, the cloud platform 100 may include a preprocessing module 200, a training module 300, a prediction module 400 and other modules, elements and components as necessary to perform its required functionalities.

In general, the preprocessing module 200 may preprocess the resumes and job descriptions, train the system word embedding models and/or phrase embedding models using the preprocessed resumes and documents, and vectorized the resulting list of vocabulary. The training module 300 may utilize the resulting vectorized dataset to train a new model within the system 10. And the prediction module 400 may run a prediction algorithm against the new trained model toe match resumes with job openings and/or vice versa.

The preprocessing module 200 may be used to preprocess the resumes and/or the job descriptions that may be used to train the system WE models and/or PE models. For example, the preprocessing module 200 may parse, clean, normalize or perform other actions regarding the resumes and job descriptions.

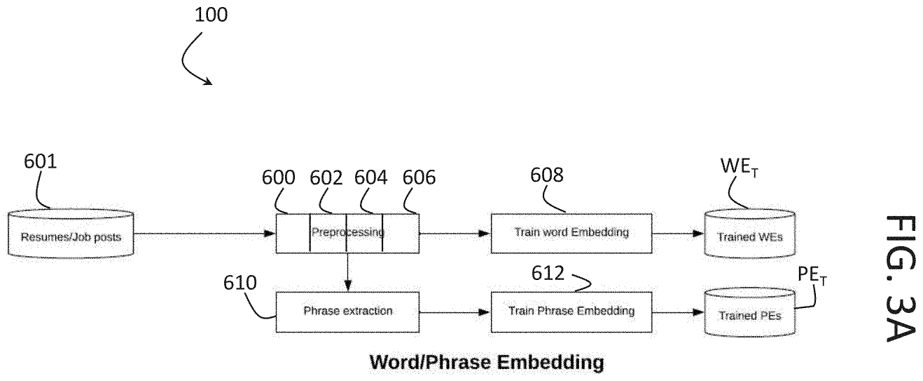

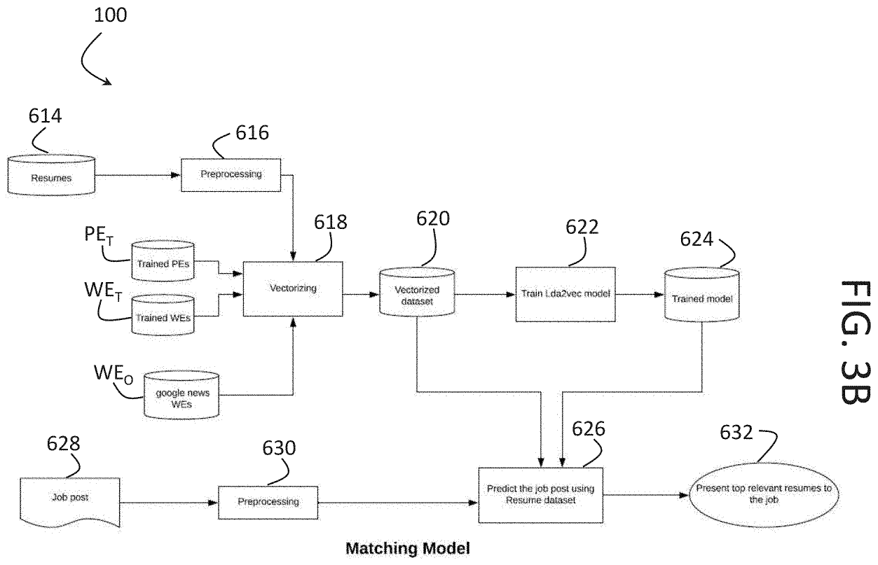

Turning to FIGS. 3A and 3B, a collection (may be a corpus and/or historical information) of raw data (e.g., raw text resumes and raw text job descriptions) may be provided at 601. In one implementation, the corpus may be commercially available such as a Wikipedia or a Google corpus. In one preferred implementation, the corpus may include up to 3.5 million resumes and/or job descriptions for a word2vec corpora. Other numbers of resumes and/or job descriptions may also be used.

In one preferred step 600, the preprocessing module 200 may parse the text within the resumes and/or job descriptions (at 601) to extract content and labeled information within each document. For example, the preprocessing module 200 may call an external API service to parse the text data and extract named entities such as without limitation, job candidate information, education, work history, work location, time frame and other data.

In another preferred step 602, the preprocessing module 200 may run a cleaning script to remove named entities from the text, e.g., education, location, city, state, dates, companies and other data.

In another preferred step 604, the preprocessing module 200 may search and remove unnecessary characters from the documents such as without limitation, email addresses, special characters, hyperlinks, social security numbers, timestamps, dates, dashes, tabs, punctuation and other unnecessary data.

In another preferred step 606, the preprocessing module 200 may tokenize and generate a vocabulary(s) from the documents. For example, the preprocessing module 200 may utilize spaCy (an open source library for advanced Natural Language Processing (NLP) applications) or other applications to tokenize the text, discard stopwords, and lemmatize each word to its base or dictionary form (also referred to as the lemma). This may return a list of vocabulary and word indices.

Note that because information contained in the resumes and/or the job descriptions may be single words or multi-word phrases, especially in the technology industries, the system 10 may utilize both word embeddings and phrase embeddings. In this way, the information may be better understood and the system 10 may provide improved results over other systems that may only use single word embeddings. For example, the single word “data” and the multi-word phrase “data scientist” may represent two distinct and mutually exclusive skillsets listed in a resume and/or a job description. By using both word embeddings models and phrase embeddings models, the system 10 may distinguish and discern the word “data” from the phrase “data scientist”.

In another preferred step 608, the preprocessing module 200 may build word embeddings from the tokenized sentences and/or the generated vocabulary resulting from one or more preprocessing steps above. In one preferred implementation, the preprocessing module 200 may utilize a statistical method such as the Word2Vec method to convert the words to real-valued vectors. The tokenized sentences and/or the generated vocabulary may be passed as inputs to Word2Vec. The result may include a set of trained word embeddings WE_{T}. This technique may capture meaningful syntactic and/or semantic regularities. Other methods may include without limitation, using an embedding layer, using the Global Vectors for Word Representation (GloVe) method, using other methods and any combination thereof.

It may be preferable that each input to Word2Vec be passed as a single long sentence. This may more accurately find the neighboring words (context) for each given target word as compared to training the WE model(s) using one sentence at a time.

In another preferred step 610, the preprocessing module 200 may extract common phrases from the resumes and/or job descriptions (preferably after the documents are parsed, cleaned and normalized) to form a phrase corpus. This may be accomplished using natural language processing (NLP) algorithms, text mining or other techniques. The phrase corpora may be built with the annotated words replaced by a list of found common phrases. The phrase corpora may then be passed as inputs to Word2Vec to be converted into real-valued vectors (at 612). The result may include a set of trained word embeddings PE_{T}.

Note that the method of new WE model learning and/or new PE model learning may be preferable over the use of pre-trained WE models and/or pre-trained PE models due to the fact that the system 10 may be utilized to evaluate vocabulary(s) relating to a specific industry (e.g., the job search industry). For example, the system 10 may evaluate job titles across a multitude of industries such as IT, healthcare, accounting, engineering, manufacturing, etc.). The text corpus used to train the WE model(s) and/or PE model(s) may preferably include a large number of resumes and/or job descriptions (e.g., thousands, tens of thousands, hundreds of thousands, millions and more). However, it is also understood that any adequate pre-trained WE model(s) and or pre-trained PE model(s) may also be used. In addition, any combination of learned and/or pre-trained WE model(s) and/or learned PE model(s) and/or pre-trained PE model(s) may also be used.

Once the system WE_{T} models and/or PE_{T} models have been learned/trained, the models may be used to vectorize a vocabulary of interest. For example, a dataset of new resumes (at 614) based on a number of categories (e.g., a list of job titles) may first be preprocessed by the preprocessing module 200 (at 616) as described above to create a list of vocabulary. The trained word embeddings WE_{T} and/or trained phrase embeddings PE_{T} may then be initialized to vectorize the list of vocabulary (at step 618) resulting in a new vectorized dataset (at 620). It should also be noted that other WEs and/or PEs may also be used instead of or in combination with the WE_{T} models and/or PE_{T} models. For example, as shown in FIG. 3B, other word embeddings WE₀ (e.g., Google News WEs) may also be used.

In one preferred step, the training module 300 may use a topic model to train the new model using the vectorized dataset. In one preferred implementation, the topic model may include Lda2vec or any other topic model(s) as shown at step 622. Lda2Vec may combine two separate algorithms (LDA and Word2Vec) into one framework.

LDA (Latent Dirichlet Allocation) may be a probabilistic top model that may understand and discover topics within a document (e.g., within the resumes and/or job descriptions). In this way, the system 10 may classify the dataset into different groups based on topics such as job title. The LDA model may create document vectors that may represent weights (e.g., weigh factors) of each topic in each document. In this way, similar documents may be grouped together.

Word2Vec may create word vectors for each word in each document to thereby understand the relationships between the words. By combining the two algorithms, Lda2Vec may build document representations on top of word embeddings. Lda2Vec may utilize the document vector from the LDA algorithm and the word vector from Word2Vec algorithm to generate “context” vectors for each word in the documents. In this way, the system 10 learns word embeddings (and context vector embeddings) for words, and, simultaneously, learns topic representations and document representations as well. This allows the system 10 to increase its accuracy in determining the meaning and context of the resumes and job descriptions.

In one example for demonstration, for the given word “python”, Word2Vec may predict neighboring words such as “java” and “C”. However, the document may concern data science, so the goal may be to create document vectors similar to the skills of “data science”. By using LDA2Vec, the system 10 may predict similar skills to “data science” plus “python” together, and may return skills such as “natural language processing (NLP)” and “machine learning (ML)”. In this way, the system 10 may discover topics (e.g., job titles) across all combinations of words.

In this implementation, Lda2Vec may be used to discover the topics and/or structures in the dataset. This may result in the new trained model in step 624. In one example, the resume data may be clustered into a predefined number of topics (e.g., job titles). Each topic may be related to a topic vector and may list the most closely related words to each topic vector. In this way, the system 10 may extract the most closely related job titles and skills related to each job title for each resume.

The output of the training model may result in a number of topics with the most relevant skills for each topic (e.g., 25 skills, 50 skills, or other numbers of skills). For example, the system 10 may define an initial number of topics (e.g., data engineer, software engineer and front end engineer) as an output from the trained model. The system 10 may then group the documents by similarity to the topics. The system 10 may then present the most relevant skill sets (e.g., the top 30 relevant skill sets). By creating the trained model (624) from the vectorized data (620), the system 10 may group the resumes and job descriptions accordingly.

In one example, the dataset may contain up to or exceed one million resumes. Due to the size of the dataset, and to increase the speed of the training, it may be preferable to utilize a framework that may allow for training to occur across multiple GPUs in parallel. In one preferred implementation, the system 10 may utilize ChainerMN to provide parallel computation implementation. Chainer may provide automatic differentiation APIs based on the define-by-run approach (e.g., dynamic computational graphs) as well as object-oriented high-level APIs to build and train neural networks. In order to handle larger size of training dataset, the system 10 may utilize ChainerMN, an extension of Chainer. ChainerMN may accelerate the training process by coordinating training across multiple GPUs or graphic processing units. In one preferred implementation, the system 10 may employ data-parallel computation for distributed training, and with synchronous model update. In this approach, each worker may own a copy of the current model, but may look at a scattered subset of the whole dataset. All workers may calculate gradients together on a minibatch in each iteration by dividing the minibatch into subsets and communicate the results across all workers. It is understood however that other frameworks may also be used that may provide this functionality.

Next, the system 10 may be used to match resumes with job descriptions using the new trained model. For example, in another preferred step 626, the prediction module 400 may find the most relevant topics for any new document (e.g., a new job description 628). The new document may be preprocessed at 630 using the same or similar preprocessing steps as described above with reference to 600, 602, 604 and 606. The system 10 may then use vectorized dataset (620) to generate the word vectors and/or phrase vectors by running it against the trained LDA2Vec model (622). The system 10 may then load the document weight matrix from the trained model (624), and initialize random weight to the new document using the average weight (or other statistical weight value(s)) from the trained model. The new document weight may then be appended to the existing document weight matrix and the prediction module 400 may discover the document's most relevant topics.

That is, the prediction module 400 may run using historical vectors to predict the new document(s) vector(s) (e.g., the new job description's vectors). By using the document matrix that was created after the training of the model, and assigning a new document weight to the new document (e.g., the weight may be the average of the document matrix that was normalized), the model may be trained using skip gram pairs. In this case, the output may be similar to that of the trained model. This may result in determining the most relevant resumes for the new job description (at step 632).

In one exemplary embodiment, the system 10 may provide a percentage of match between the resumes and the job postings based on a set of uniquely programmed datasets. For example, the system 10 may score and provide percentage of match metrics for each resume for topics such as, without limitation, skillset qualifications, number of positions held in the required skillset, years of expertise, industry experience, degrees or certification requirements, time in traffic during rush hour from the job seeker's residence to the employer's office location (not just the mileage), overall quality of the resume, employment gaps (if present) and other topics. The system 10 may then utilize various degrees of scoring points over the topics to mathematically calculate an overall match percentage of each resume with each applicable job posting.

A person of ordinary skill in the art will understand, upon reading this specification, that while the above example may describe the use of the system 10 to determine the most relevant resumes for a particular job description, the system 10 may also be used to determine the most relevant job descriptions for a particular resume. The system 10 may also be used to compare one or more resume(s) to other resumes, one or more job descriptions to other job descriptions, and any combination thereof.

In one exemplary embodiment hereof, the system 10 may provide an in-depth report of the job seekers qualifications with a match percentage to the job posting(s) taking into consideration one or more various data points. For example, each of the data points may have a weighted value based on relevant expertise, industry experience, location, education or training, years of experience, intangibles, other data points and any combination thereof. Once the data point values may be calculated, the job seeker may be given a percentage score to the job posting requirements. This functionality may be referred to as the scouting report.

In another exemplary embodiment hereof, the system may automatically discover and flag employment gaps in the job seekers resume longer than a particular threshold (e.g., 3 months) and may alert the employer of the findings for further clarification. This feature may eliminate any false negatives that otherwise may prevent a potential employer having further interest in the candidate. This functionality may be referred to as the hopper.

In another exemplary embodiment hereof, the system 10 may allow the job seeker to identify and view any contacts they may have (e.g., on any social media platforms such as LinkedIn) that may work at the company with the job posting. This may allow the job seeker to connect with potential first degree contacts that might be able to assist with the hiring process. This functionality may be referred to as six degrees of separation.

In another exemplary embodiment hereof, the system 10 may provide the estimated travel time (e.g., during rush hour) from the job seeker's home to the employer's work location (and back) so that the job seeker may intelligently determine if the daily drive is feasible. By providing the estimated travel time instead of simply providing the total miles between the locations, the job seeker may better understand the feasibility of the commute. This functionality may be referred to as time travel.

In another exemplary embodiment hereof, the system 10 may be pre-programmed to search for and identify resumes that may be pertinent for a particular job description (e.g., resumes that score a percentage of relevance to the job description above a predefined threshold). This may be preferable if a particular employer may be interested in a continual or on-going search for potential job candidates that may have a particular set of pre-defined skills, experience, schooling, or other characteristics. In this case, the system 10 may be programmed to with a specific set of algorithms to address the requirements of each company or department in finding suitable candidates. This functionality may be referred to as job post repetition.

In another exemplary embodiment hereof, the system 10 may utilize a first resume and search for other resumes that may match the first resume. In this way, an employer may provide a resume to the system 10 and may wish for the system 10 to find other resumes of other potential job candidates with similar experience, background and expertise. The system 10 may evaluate its pool of resumes and semantically compare the first resume with the resumes in the pool to recommend qualified candidates to the employer. This functionality may be referred to as the rainmaker.

In another exemplary embodiment hereof, the system 10 may provide career path and growth recommendations to job seekers. Whether a job seeker may be looking to grow and get promoted in his/her existing career or change/enter a new career, the system 10 may recommend jobs that are most suitable in achieving the desired goal(s). This functionality may be referred to as the counselor.

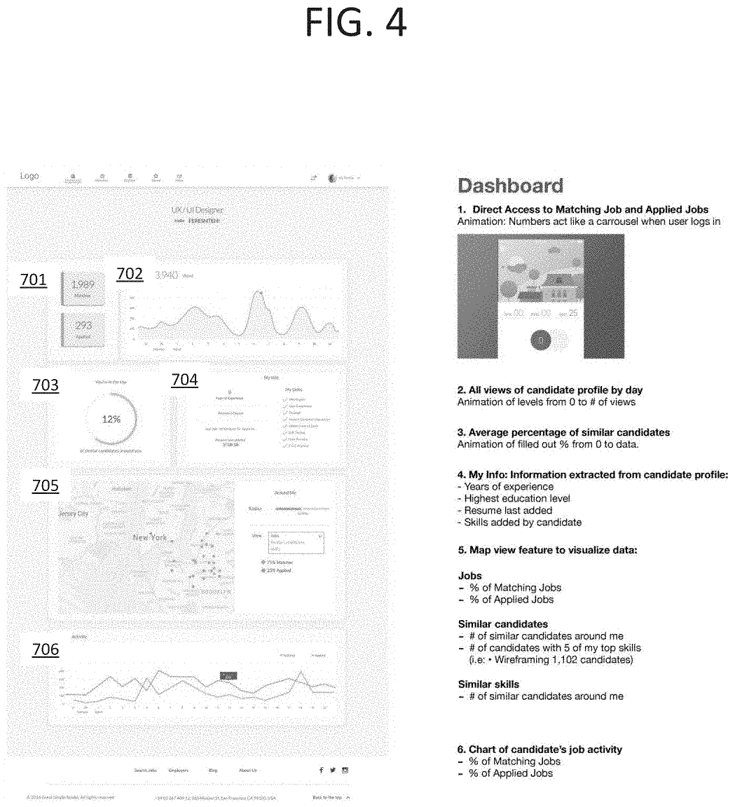

Turning now to FIGS. 4-15, aspects of the system 10 will be described in further detail through the descriptions of work flows, interfaces and dialogs.

FIGS. 4-17 depict example dashboard dialogs that the system 10 may make available to the user of the system 10. The dashboard dialogs may include tools, information displays, and other types of elements that the user may use to optimize his/her experience.

In one example, FIG. 4 may depict a user dashboard with the following:
701: Direct access to matching jobs and jobs applied for. This may include an animation such as the numbers presented as a carousel when the user logs in.
702: All views of the candidate profile sorted by day. This may include an animation of levels from zero to number of views.
703: Average percentage of similar candidates. This may include an animation of filled out % from zero to number of views.
704: My Info: Includes information extracted from the candidate's profile, such as, without limitation, years of experience, highest education level, resume last added and skills added by candidate.
705: Map view to visualize data:
   Jobs: percentage of matching jobs, percentage of jobs applied for
   Similar candidates: number of similar candidates in similar geographical location, number of candidates with similar top skills.
706: Chart of candidate's job search activity, including without limitation, percentage of matching jobs, percentage of jobs applied for.

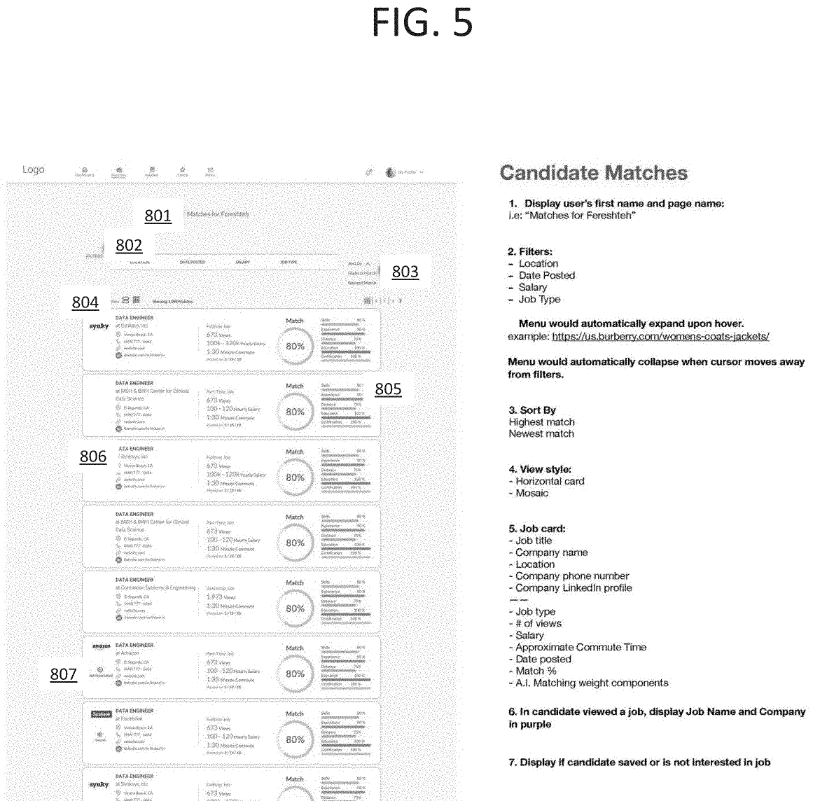

In one example, FIG. 5 may depict information regarding the candidate job matches, such as:
801: Display user's first name and page name
802: Filters such as location, date posted, salary, job type. The menu may automatically expand upon mouse over/hover. The menu may collapse when cursor may move away.
803: Sort by highest match, newest match
804: View style such as horizontal card, mosaic
805: Job card including job title, company name, location, company phone number, company LinkedIn profile, job type, number of views, salary, approximate commute time, date posted, match percentage, AI matching weight components
806: If the candidate has viewed a particular job posting, display the job name and company name in a pre-specified color (e.g., purple)
807: Display whether or not the candidate has saved or is interested in the job posting

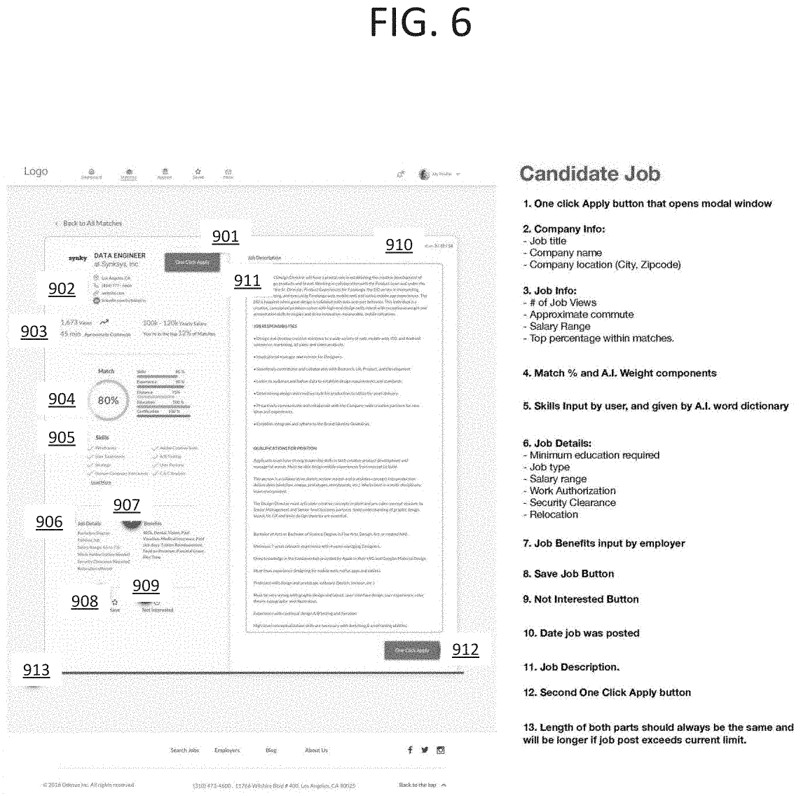

In one example, FIG. 6 may depict information regarding a particular candidate job, such as:
901: One click APPLY button that opens modal window
902: Company info such as job title, company name, company location
903: Job info such as number of job views, approximate commute, salary range, top percentage within matches
904: Match percentage and AI weight components
905: Skills input by the user, and given by AI word dictionary
906: Job details such as minimum education required, job type, salary range, work authorization, security clearance, relocation
907: Job benefits input by employer
908: Save job button
909: Not interested button
910: Date job was posted
911: Job description
912: Second one click APPLY button
913: Length of both parts should always be the same and will be longer if job post exceeds current limit

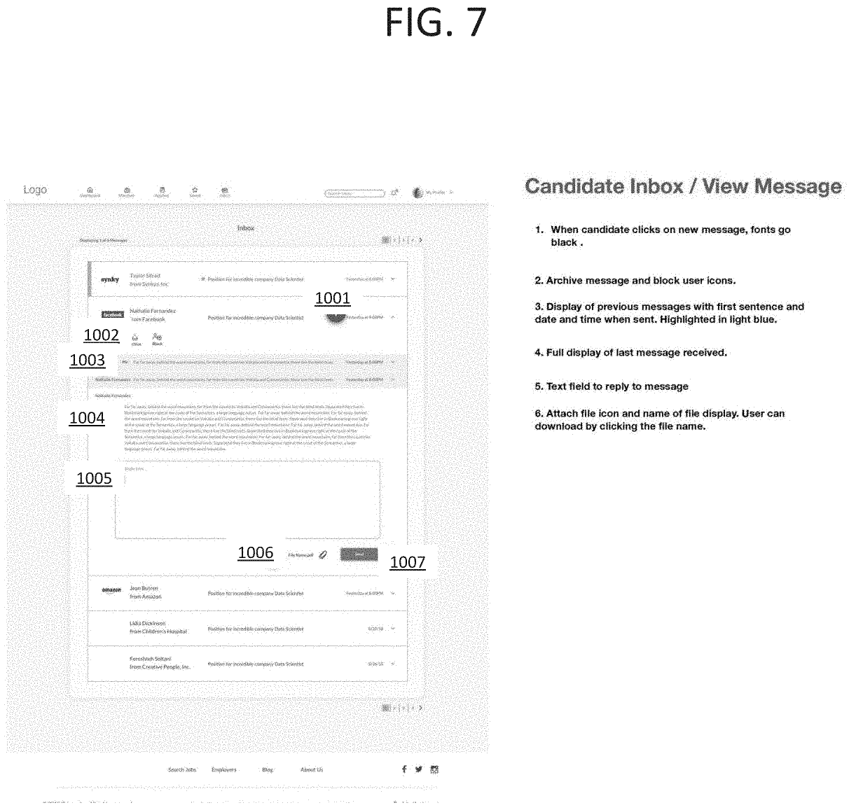

In one example, FIG. 7 may depict a candidate inbox and view message functionality, such as:
1001: When candidate clicks on a new message, fonts may go black
1002: Archive message and block user icons
1003: Display of previous messages with first sentence and data and time when sent. May be highlighted in light blue.
1004: Full display of last message received
1005: Text field of last message received
1006: Attach file icon and name of file display. User can download by clicking on the file name.

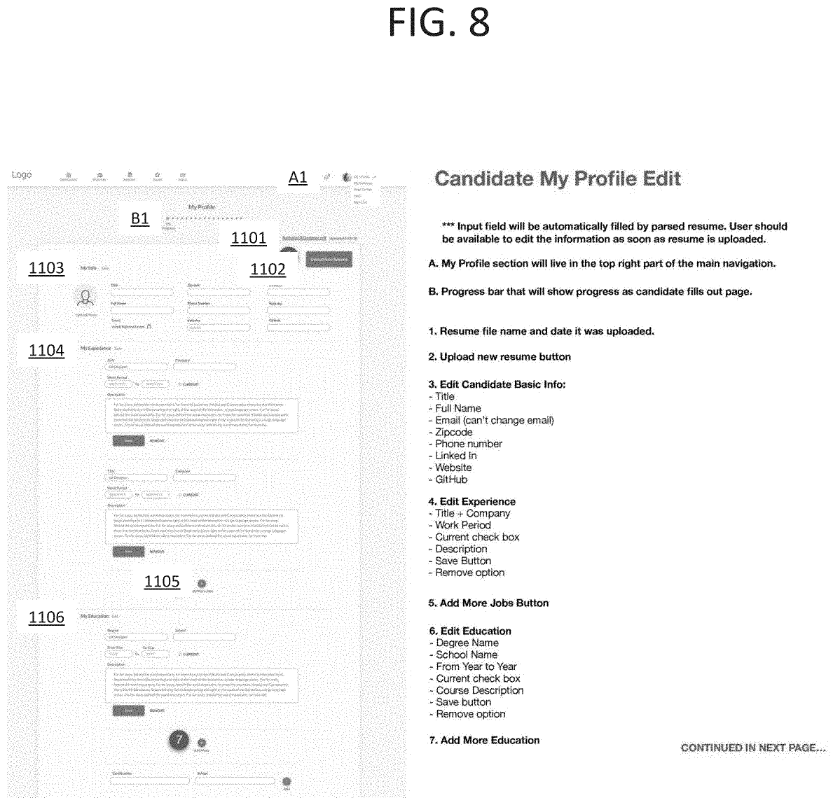

In one example, FIG. 8 may depict a candidate profile section, such as shown below. Note that the input field(s) may be automatically filled by parsed resume.
A1: The My Profile section may live in the top right part of the main navigation
B1: Progress bar that will show progress as candidate fills out profile
1101: Resume file name date it was uploaded
1102: Upload new resume button
1103: Edit basic candidate info such as title, full name, email, zip code, phone number, LinkedIn profile, website, GitHub profile
1104: Edit experience such as title and company, work period, current check box, description, save button, remove option
1105: Add more jobs button
1106: Edit experience such as degree name, school name, years, current check box, course description, save button, remove option
1107: Add more education

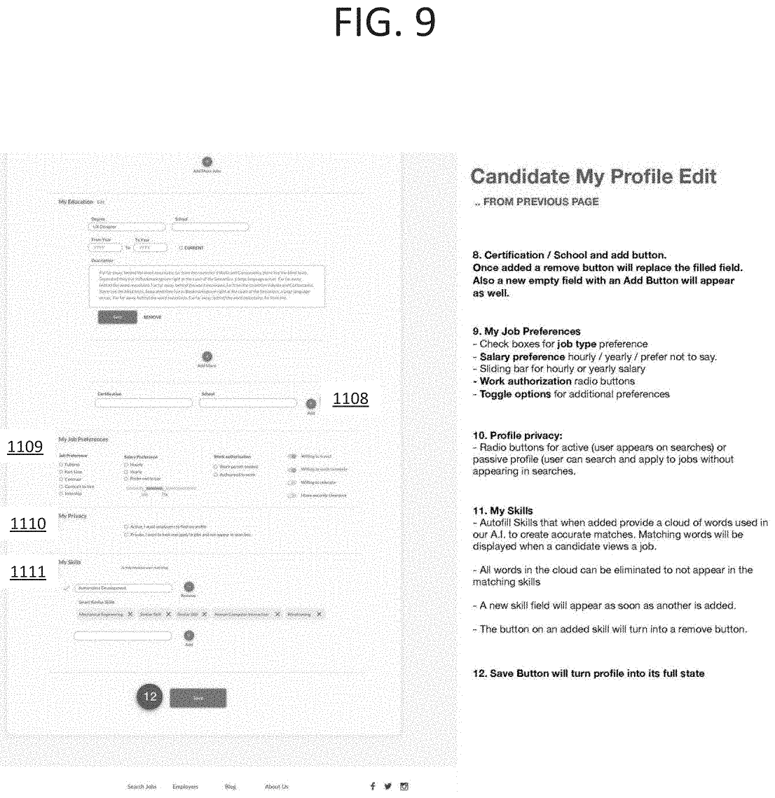

In one example, FIG. 9 may be a continuation of the dialog shown in FIG. 8, and may include:
1108: Certification/School and add button. Once added a remove button will replace the filled field. Also a new empty field with an ADD button will appear
1109: My job preferences including check boxes for job type preferences, salary preferences (hourly, yearly, prefer not to say), sliding bar for hourly or yearly salary, work authorization radio buttons, toggle options for additional preferences
1110: Profile privacy such as radio buttons for active (use appears on searches) or passive (user can search and apply for jobs without appearing in searches)
1111: My skill including autofill skills that when added provide a cloud of words used in the system 10 AI to create accurate matches. Matching words will be displayed when a candidate views a job. Words in the cloud can be eliminated to not appear in the matching skills. The button on an added skill with turn into a remove button.
1112: Save button will turn profile into its full state

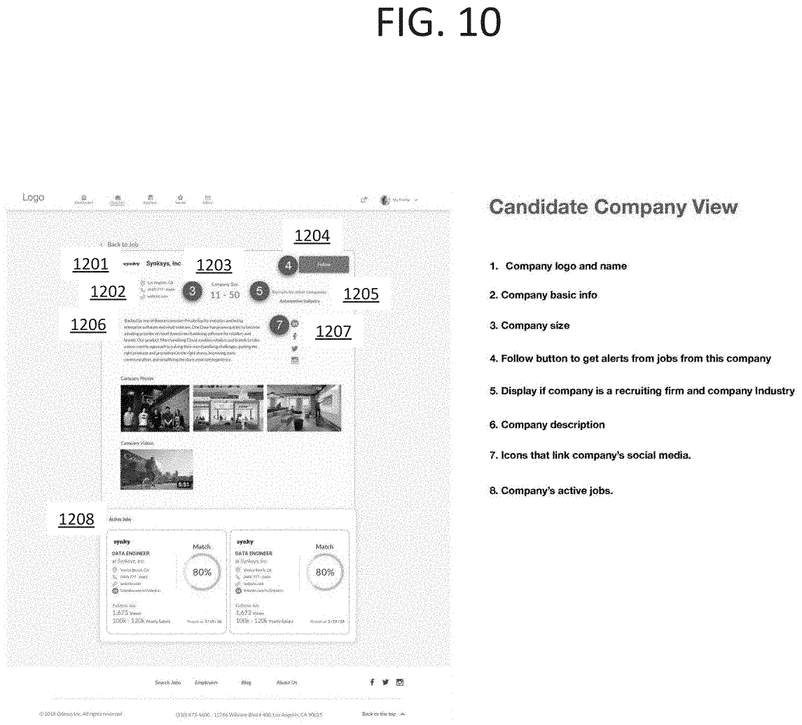

In one example, FIG. 10 may depict information regarding a candidate company, such as:
1201: Company logo and name
1202: Company basic information
1203: Company size
1204: Follow button to receive job alerts from the company
1205: Display if company is a recruiting firm and company industry
1206: Company description
1207: Icons that link to company's social media profiles
1208: Company's active job listings

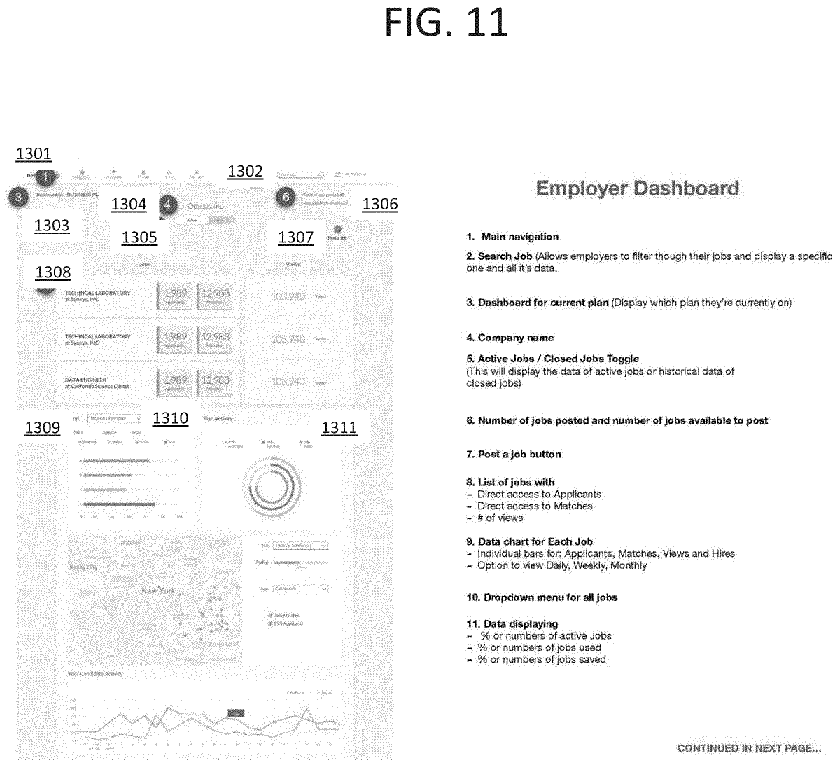

In one example, FIG. 11 may depict an employer dashboard with information such as:
1301: Main navigation
1302: Search job: Allows employers to filter through their job postings and display a specific posting and all of its data
1303: Dashboard for current plan (displays which plan they are currently on)
1304: Company name
1305: Active jobs/closed jobs toggle (This will display the data of active jobs or historical data of closed jobs)
1306: Number of jobs posted and number of jobs available to post
1307: Post a job button
1308: List of jobs with: direct access to applicants, direct access to matches, number of views
1309: Data chart for each job, including, individual bars for applicants, matches views and hires, option to view daily, weekly and monthly
1310: Dropdown menu for all jobs
1311: Data display percentage or numbers of active jobs, percentage or numbers of jobs used, percentage or number of jobs saved

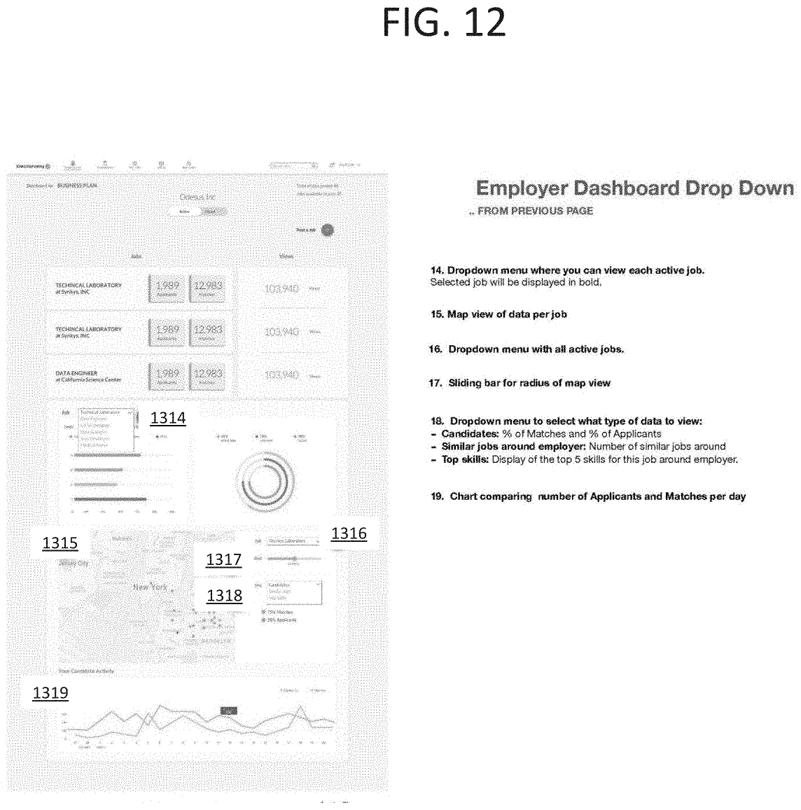

In one example, FIG. 12 may be a continuation of the employer dashboard in FIG. 11, and may include:
1314: Dropdown menu where the user can view each active job (selected job will be shown in bold)
1315: Map view of data per job
1316: Dropdown menu with all active jobs
1317: Sliding bar for radius of map view
1318: Dropdown menu to select what type of data to view, such as, Candidates (percentage of matches and percentage of applicants), similar jobs around employer (number of similar jobs close to location of employer), top skills (display of top skills for the job close in location of employer).
1319: Chart comparing number of applicants and matches per day

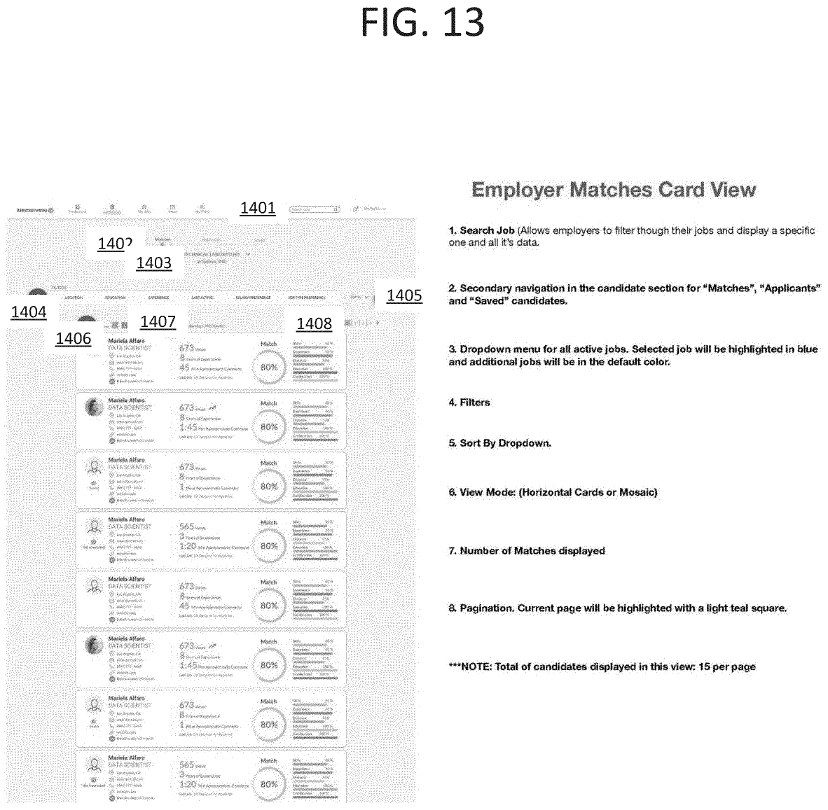

In one example, FIG. 13 may depict an employer matches card view with information such as:
1401: Search job (allows employers to filter through their job postings and display a specific posting and its data
1402: Secondary navigation in the candidate section for matches, applicants and saved candidates
1403: Dropdown menu for active jobs. Selected job will be highlighted in blue and additional jobs will be shown in the default color
1404: Filters
1405: Sort by dropdown
1406: View mode (horizontal cards or mosaic)
1407: Number of matches displays
1408: Pagination (current page will be highlighted in light teal square)

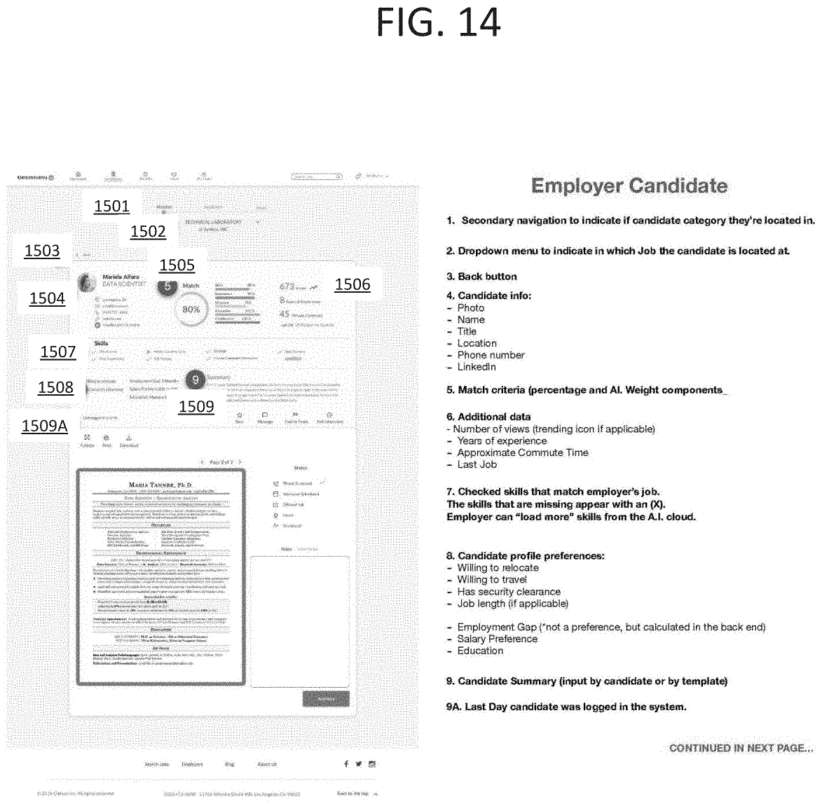

In one example, FIG. 14 may depict employer candidate information such as:
1501: Secondary information to indicate the candidate category
1502: Dropdown menu to indicate in which job the candidate is located in
1503: Back button
1504: Candidate information including photo, name, title, location, phone number, LinkedIn profile
1505: Match criteria (percentage and system 10 AI weight components)
1506: Number of jobs posted and number of jobs available to post
1507: Checked skills that match employer's job posing. The skill that are missing appear with an (X). Employer can load more skill in the system 10 AI cloud.
1508: Candidate profile preferences including willing to relocate, willing to travel, has security clearance, job length (if applicable)
1509: Candidate summary (input by candidate or by template)
1509A: Last day candidate was logged into system

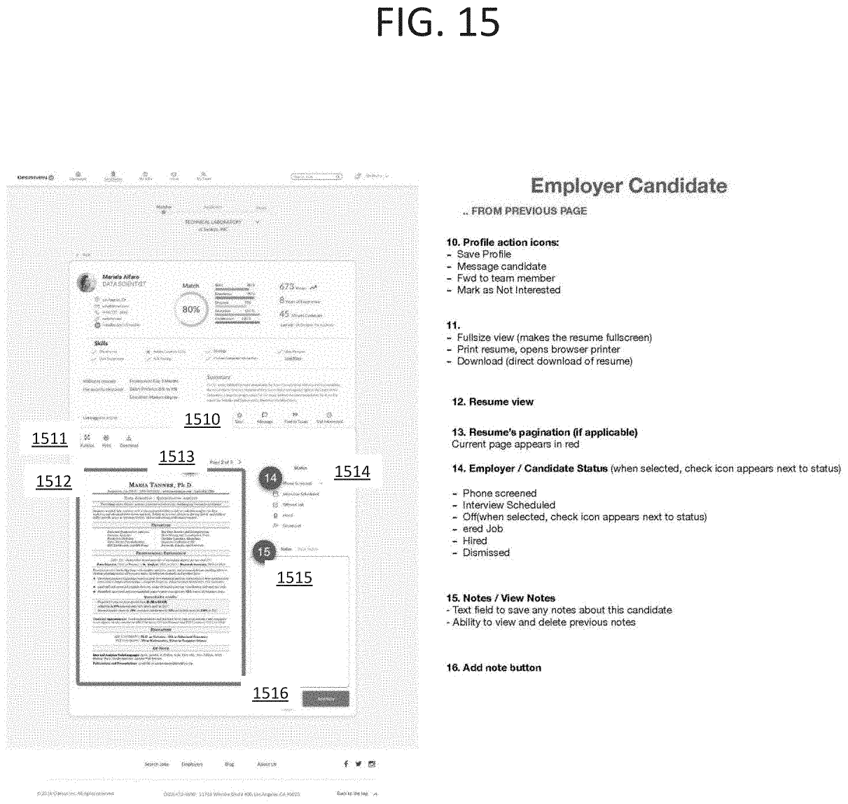

In one example, FIG. 15 may be a continuation of the employer candidate information in FIG. 14, and may include:
1510: Profile action icons such as save profile, message candidate, forward to team member, mark as not interested
1511: Full size view (makes resume full screen), print resume (opens browser printer), download (direct download of resume)
1512: Resume view
1513: Resume's pagination (if applicable). Current page appears in red.
1514: Employer/Candidate Status (when selected, check icon appears next to status) including phone screened, interview scheduled, offered job (when selected, check icon appears next to status), hired, dismissed
1515: Notes/View notes such as text field to save any notes about the candidate, ability to view and delete previous notes
1516: Add note button

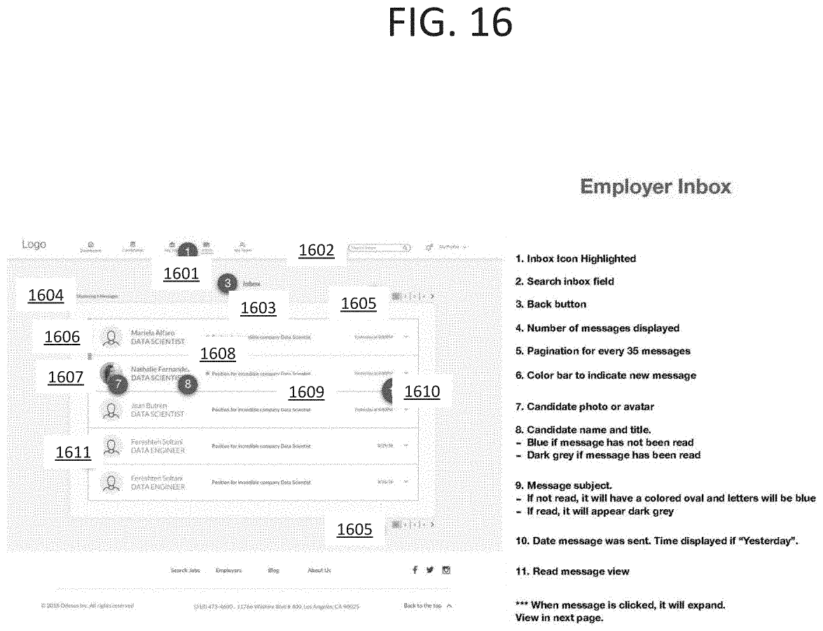

In one example, FIG. 16 may depict an employer inbox with information such as:
1601: Inbox icon highlighted
1602: Search inbox field
1603: Back button
1604: Number of messages displayed
1605: Pagination for every number of pages
1606: Color bar to indicate new message
1607: Candidate photo or avatar
1608: Candidate name and title (blue if message has not been read, dark grey if message has been read)
1609: Message subject (if not read, will have a colored oval and letters will be blue. If read, will appear dark grey)
1610: Date message was sent. Time displayed if “yesterday”.
1611: Read message view. When message is clicked, it will expand.

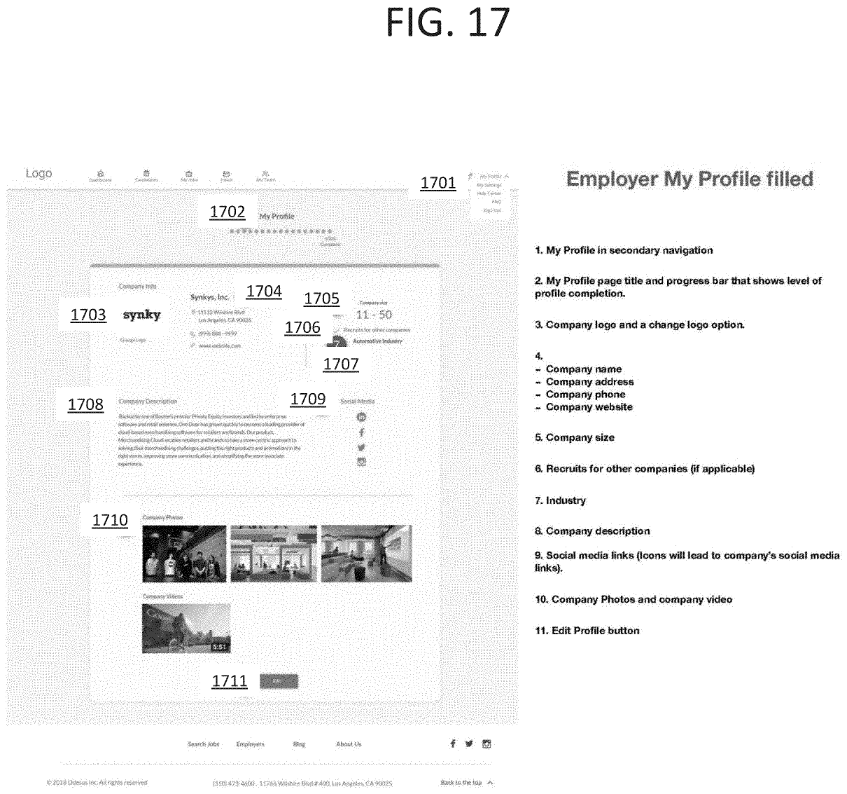

In one example, FIG. 17 may depict an employer profile filled with information such as:
1701: My Profile in secondary navigation
1702: My Profile page title and progress bar that shows level of profile completion
1703: Company logo and a change logo option
1704: Company name, company address, company phone, company website
1705: Company size
1706: Recruits for other companies (if applicable)
1707: Industry
1708: Company description
1709: Social media links (icons will lead to company's social media profiles)
1710: Company photographs and/or company videos
1711: Edit profile button

It is understood by a person of ordinary skill in the art, upon reading this specification, that the dialogs depicted in the figures and/or described above are meant for demonstration, and that the system 10 may include other dialogs not shown, may not include all of the dialogs shown, or any combination thereof. The dialogs are depicted to demonstrate example functionalities that the system 10 may have. It is understood however, that the system 10 may include other functionalities not depicted in the figures, and that the scope of the system 10 is not limited in any way by the dialogs depicted and described, or by the functionalities that the dialogs may provide.

### Computing

The functionalities, applications, services, mechanisms, operations, and acts shown and described above are implemented, at least in part, by software running on one or more computers.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed computers, special purpose computers and computing devices. One or more such computers or computing devices may be referred to as a computer system.

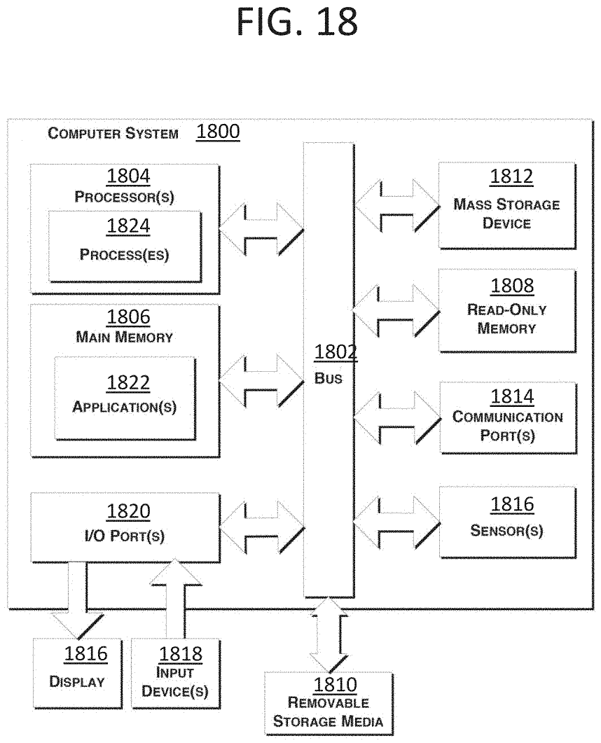

FIG. 18 is a schematic diagram of a computer system 1800 upon which embodiments of the present disclosure may be implemented and carried out.

According to the present example, the computer system 1800 includes a bus 1802 (i.e., interconnect), one or more processors 1804, a main memory 1806, read-only memory 1808, removable storage media 1810, mass storage 1812, and one or more communications ports 1814. Communication port(s) 1814 may be connected to one or more networks (not shown) by way of which the computer system 1800 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 1804 can be any known processor, such as, but not limited to, an Intel® Itanium® or Itanium 2® processor(s), AMD® Opteron® or Athlon MP® processor(s), or Motorola® lines of processors, and the like. Communications port(s) 1814 can be any of an Ethernet port, a Gigabit port using copper or fiber, or a USB port, and the like. Communications port(s) 1814 may be chosen depending on a network such as a Local Area Network (LAN), a Wide Area Network (WAN), or any network to which the computer system 1800 connects. The computer system 1800 may be in communication with peripheral devices (e.g., display screen 1816, input device(s) 1818) via Input/Output (I/O) port 1820.

Main memory 1806 can be Random Access Memory (RAM), or any other dynamic storage device(s) commonly known in the art. Read-only memory (ROM) 1808 can be any static storage device(s) such as Programmable Read-Only Memory (PROM) chips for storing static information such as instructions for processor(s) 1804. Mass storage 1812 can be used to store information and instructions. For example, hard disk drives, an optical disc, an array of disks such as Redundant Array of Independent Disks (RAID), or any other mass storage devices may be used.

Bus 1802 communicatively couples processor(s) 1804 with the other memory, storage and communications blocks. Bus 1802 can be a PCI/PCI-X, SCSI, a Universal Serial Bus (USB) based system bus (or other) depending on the storage devices used, and the like. Removable storage media 1810 can be any kind of external storage, including hard-drives, floppy drives, USB drives, Compact Disc—Read Only Memory (CD-ROM), Compact Disc—Re-Writable (CD-RW), Digital Versatile Disk—Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements which are appropriate to perform the methods.

As shown, main memory 1806 is encoded with application(s) 1822 that support(s) the functionality as discussed herein (the application(s) 1822 may be an application(s) that provides some or all of the functionality of the services/mechanisms described herein. Application(s) 1822 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 1804 accesses main memory 1806 via the use of bus 1802 in order to launch, run, execute, interpret or otherwise perform the logic instructions of the application(s) 1822. Execution of application(s) 1822 produces processing functionality of the service related to the application(s). In other words, the process(es) 1824 represent one or more portions of the application(s) 1822 performing within or upon the processor(s) 1804 in the computer system 1800.

It should be noted that, in addition to the process(es) 1824 that carries (carry) out operations as discussed herein, other embodiments herein include the application 1822 itself (i.e., the un-executed or non-performing logic instructions and/or data). The application 1822 may be stored on a computer readable medium (e.g., a repository) such as a disk or in an optical medium. According to other embodiments, the application 1822 can also be stored in a memory type system such as in firmware, read only memory (ROM), or, as in this example, as executable code within the main memory 1806 (e.g., within Random Access Memory or RAM). For example, application(s) 1822 may also be stored in removable storage media 1810, read-only memory 1808, and/or mass storage device 1812.

Those of ordinary skill in the art will understand that the computer system 600 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first,” “second,” and so on, in the description and claims, are used to distinguish or identify, and not to show a serial or numerical limitation. Similarly, letter labels (e.g., “(A)”, “(B)”, “(C)”, and so on, or “(a)”, “(b)”, and so on) and/or numbers (e.g., “(i)”, “(ii)”, and so on) are used to assist in readability and to help distinguish and/or identify, and are not intended to be otherwise limiting or to impose or imply any serial or numerical limitations or orderings. Similarly, words such as “particular,” “specific,” “certain,” and “given,” in the description and claims, if used, are to distinguish or identify, and are not intended to be otherwise limiting.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

The present invention also covers the exact terms, features, values and ranges, etc. in case these terms, features, values and ranges etc. are used in conjunction with terms such as about, around, generally, substantially, essentially, at least etc. (i.e., “about 3” or “approximately 3” shall also cover exactly 3 or “substantially constant” shall also cover exactly constant).

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components unless specifically so stated.

It will be appreciated that variations to the embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

The present invention also covers the exact terms, features, values and ranges, etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” (“e.g.,”) and the like, is merely intended to better illustrate the invention and does not indicate a limitation on the scope of the invention unless specifically so claimed.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

What is claimed:

1. A computing system comprising:
at least one processor unit;
at least one memory unit coupled with the at least one processor unit;
computer readable instructions embodied in the memory unit and executable by the processor unit, wherein execution of the instructions by the processor unit causes the computing system to perform a method, the method comprising:
(A) training at least one word embedding based on a first corpus of text;
(B) training at least one phrase embedding based on a second corpus of text;
(C) using the at least one trained word embedding from (A) and the at least one trained phrase embedding from (B) to vectorize at least one dataset to create at least one vectorized dataset;
(C) using the at least one vectorized dataset to train a prediction model; and
(D) using the prediction model to measure the relevance of a first document to a second document.

2. The method of claim 1 wherein the first corpus of text is a corpus of resumes.

3. The method of claim 1 wherein the first corpus of text is a corpus of job descriptions.

4. The method of claim 1 wherein the second corpus of text is a corpus of resumes.

5. The method of claim 1 wherein the second corpus of text is a corpus of job descriptions.

6. The method of claim 1 wherein the first document is a resume and the second document is a job description.

7. The method of claim 1 wherein the first document is a job description and the second document is a resume.

8. The method of claim 1 wherein the training in (A) includes using a word2vec model.

9. The method of claim 1 wherein the training in (B) includes extracting phrases from the second corpus of text and using a word2vec model.

10. The method of claim 1 wherein the training in (C) includes using an LDA2vec model.

11. The method of claim 1 wherein the first corpus of text and the second corpus of text is the same.
